(19) United States
(12) Patent Application Publication
(10) Pub. No.: US 2010/0231933 A1
(43) Pub. Date: Sep. 16, 2010

(54) DYNAMIC PRODUCTION BASED ON PERCEIVED PAGE VALUE

(75) Inventors: Javier A. Morales, Rochester, NY (US); Michael E. Farrell, Webster, NY (US)

Correspondence Address: ORTIZ & LOPEZ, PLLC, P.O. Box 4484, Albuqueque, NM, 87196-4484, US

(73) Assignee: Xerox Corporation

(21) Appl. No.: 12/403,086

(22) Filed: Mar. 12, 2009

(51) Int. Cl. G06F 15/00

(52) U.S. Cl. 358/1.9

(57) ABSTRACT

Document descriptions, typically written in a page description language, are automatically transformed down to the page level based on the perceived value of the content of each page. In normal production, documents, printers, and entire printing facilities typically have a set of predefined production parameters that govern the production and appearance of all documents. In enhanced operation, identification rules automatically generate perceived page values for each document page. The pages can be grouped into page subsets based on their perceived values. The Transformation directives can then be selectively invoked to alter the production parameters used for printing the pages within certain page subsets and thereby alter the final appearance, plex, media, or color space of the printed pages within those subsets.

### TECHNICAL FIELD

Embodiments are related to printing, print job processing and to page description languages. Embodiments also relate to automated identification of page content within data files and automated data transformations that alter page content or appearance.

### BACKGROUND

Printing facilities are often called on to print multitudinous copies of similar documents that are slightly customized based on their intended recipient. For example, a printing facility can print credit card bills which are then subsequently stuffed into envelopes and mailed. Each credit card bill is slightly customized because different recipients have different names, different addresses, different charges and different balances. The differences can lead to variations in the number of bill pages, perhaps including advertising content, that are sent to each person. Regardless, each credit card bill is a printed document.

FIG. 7, labeled as “Prior Art”, illustrates a document description 701 being printed to produce a document 122. A document description 701 is typically an electronic computer file containing data and instructions written in a page description language (PDL). Some of the PDL data and instructions compose page descriptions such as page description 1 702, page description 2 703, and page description 3 704. The data and instructions that are not part of a page description typically contain accounting information, versioning information, printing instructions, and other items that relate to the entire document description 701. A printing engine 121 processes the document description 701 to produce a document 122 and each page description results in a page. As illustrated, page description 1 702 is printed as page 1 705, page description 2 703 is printed as page 2 706, and page description 3 704 is printed as page 3 707.

Printing facilities usually contain document management systems that electronically store the document descriptions, preprint facilities that prepare document descriptions for printing, and printing engines that print the documents. The printing engines are capable of printing the documents onto a variety of media, using a variety of inks or dyes, and producing a variety of document finishings. The vast number of documents to be printed often results in the use of a set of default printing parameters for every page regardless of its content. Lower quality printing is faster and less expensive than higher quality. As such, most printing facilities print at a default medium quality with the result that high value content such as graphics (images, logos, etc.) is mostly recognizable while lower value content, such as text, is no crisper or clearer than a lower quality printing would yield. Systems and methods for automatically matching the appearance or print quality of each printed page to its perceived value or content are needed.

### BRIEF SUMMARY

Aspects of the embodiments address limitations and flaws in the prior art by automatically classifying the page descriptions in a document description into page subsets and subsequently invoking transformation directives to thereby cause predefined alterations to the page descriptions in the page subsets.

It is therefore an aspect of the embodiments that a document production system be configured with production parameters that serve as default production parameters for all documents printed by the document production system. The document production system accepts document descriptions typically containing numerous page descriptions. Document descriptions are typically electronic computer files containing data and instructions written in a page description language (PDL). Printing a page description produces a page. Printing a document description produces all of a document's pages.

It is also an aspect of the embodiments that identification rules and transformation directives are defined. Each identification rule can be associated with one or more transformation directive. An identification module can use the identification rules to classify page descriptions into page subsets. As such, each page set is in essence defined by or described by the identification rule matching the page descriptions in the page subset. Each page subset is thereby also associated with every transformation directive associated with the identification rule defining the page subset. A transformation module can interpret the transformation directives to thereby alter the page descriptions in the page subsets to produce an altered document description.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention

FIG. 1 illustrates a document production system producing a document containing pages identified by identification rules and transformed by transformation directives in accordance with aspects of the embodiments;

FIG. 2 illustrates a system transforming a desired document description into an altered document description in accordance with aspects of the embodiments;

FIG. 3 illustrates examples of identification rules in accordance with aspects of the embodiments;

FIG. 4 illustrates examples of transformation directives in accordance with aspects of the embodiments;

FIG. 5 illustrates a high level flow diagram of producing a document containing pages matching identification rules and transformed by transformation directives in accordance with aspects of the embodiments;

FIG. 6 illustrates a high level flow diagram of configuring and operating a document production system to produce a document containing pages matching identification rules and transformed by transformation directives in accordance with aspects of the embodiments; and

FIG. 7, labeled as “Prior Art”, illustrates a document description being printed to produce a document.

### DETAILED DESCRIPTION OF THE INVENTION

The particular values and configurations discussed in these non-limiting examples can be varied and are cited merely to illustrate embodiments and are not intended to limit the scope of the invention.

Document descriptions, typically written in a page description language, are automatically transformed down to the page level based on the perceived value of the content of each page. In normal production, documents, printers, and entire printing facilities typically have a set of predefined production parameters that govern the production and appearance of all documents. In enhanced operation, identification rules automatically generate perceived page values for each document page. The pages can be grouped into page subsets based on their perceived values. The Transformation directives can then be selectively invoked to alter the production parameters used for printing the pages within certain page subsets and thereby alter the final appearance, plex, media, or color space of the printed pages within those subsets.

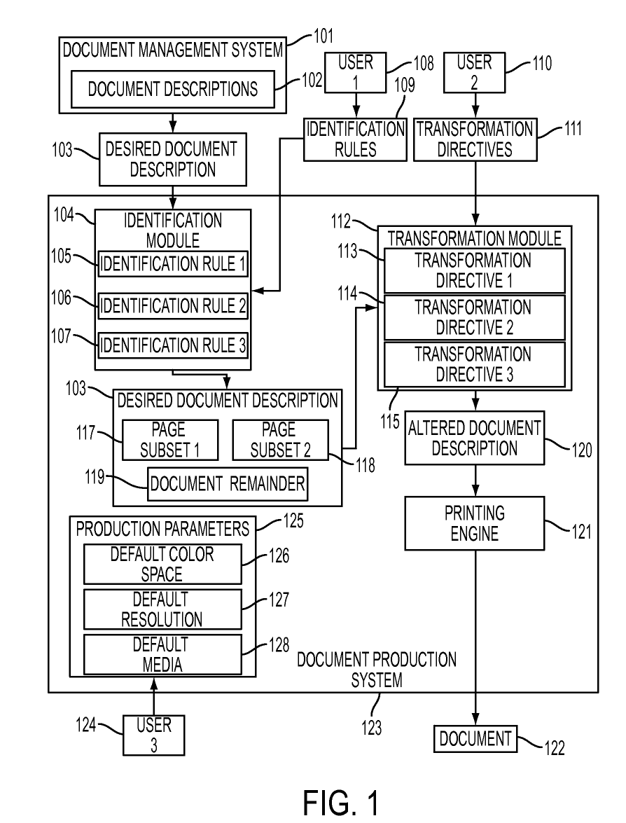

FIG. 1 illustrates a document production system 123 producing a document 122 containing pages identified by identification rules 109 and transformed by transformation directives 111 in accordance with aspects of the embodiments. The document production system 123 contains an identification module 104 and a transformation module 112. A first user 108 can enter identification rules 109 into the identification module 104. The identification module 104 is illustrated as having had identification rule 1 105, identification rule 2 106, and identification rule 3 107 already entered. Similarly, a second user 110 can enter transformation directives 111 into the transformation module 112. The transformation module 112 is illustrated as having had transformation directive 1 113, transformation directive 2 114, and transformation directive 3 115 already entered.

A document management system 101 can store a great many document descriptions 102 one of which is a desired document description 103 that is to be printed. Historically, the desired document description 103 would be submitted to the document production system 123 to be printed using production parameters 125 entered by a third user 124 who set the production parameters 125 to default values such as a default color space 126, a default resolution 127 and default media 128. Note that the three exemplary users 108, 110, 124 can all be the same person.

A more appealing result can be obtained when the desired document description 103 is first inspected by an identification module 104 that classifies the page descriptions in the desired document description 103 into page subsets. As illustrated, the desired document description 103 is entered into the document management system 123 and inspected by the identification module 104 to identify page subsets within the desired document description 103. In the illustrated example of FIG. 1, the identification module 104 has found page descriptions matching identification rule 1 105 and placed them in page subset 1 117. The page descriptions matched by identification rule 2 106 have been placed in page subset 2 118. No pages matched identification rule 3 107. The document remainder 119 is a page subset containing all the page descriptions that the identification module 104 did not identify. If no page descriptions are identified, then the document remainder contains all the page descriptions and all the other page subsets are empty.

The transformation module 112 transforms the pages descriptions in the page subsets to produce an altered document description 120. Each identification rule is associated with at least one transformation directive. Here, identification rule 1 105 is associated with transformation directive 1 113, identification rule 2 106 is associated with transformation directive 2 114, and identification rule 3 107 is associated with transformation directive 3 115. As such, the transformation module transforms the page descriptions in page subset 1 117 according to the dictates of transformation directive 1 113 and transforms the page descriptions in page subset 2 118 according to the dictates of transformation directive 2 114 to produce altered document description 120.

The altered document description 120 is passed to a printing engine 121 that prints it to produce a document 122 that can be delivered to a recipient.

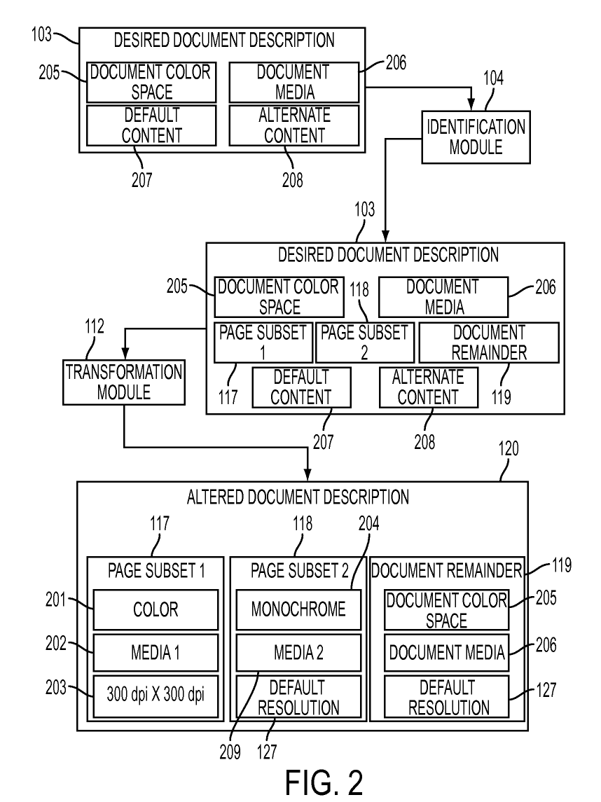

FIG. 2 illustrates a system transforming a desired document description 103 into an altered document description 120 in accordance with aspects of the embodiments. The desired document description 103 can specify content and printing parameters such as a document color space 205, document media 206, default content 207, and alternate content 208. In the illustrated example, document parameters override the production parameters 125 although in other examples default parameters 125 could override document parameters.

The identification module 104 inspects the desired document description 103 to classify the page descriptions into page subset 1 117, page subset 2 118, and document remainder 119. The desired document description 103 is then passed to the transformation module 112 to produce the altered document description 120. Before alteration, all the page descriptions were to be printed with the same color space, on the same media, and at the same resolution. The transformation module 112 changed that. The page descriptions in page subset 1 117 are to be printed in color 201 on media 1 202 at a dots-per-inch (dpi) resolution of 300 dpi×300 dpi. The page descriptions in page subset 2 118 are to be printed in monochrome 204 on media 2 209 at the default resolution 127. The page descriptions in the document remainder 119 are to be printed in the document color space 205 on the document media 206 at the default resolution 127.

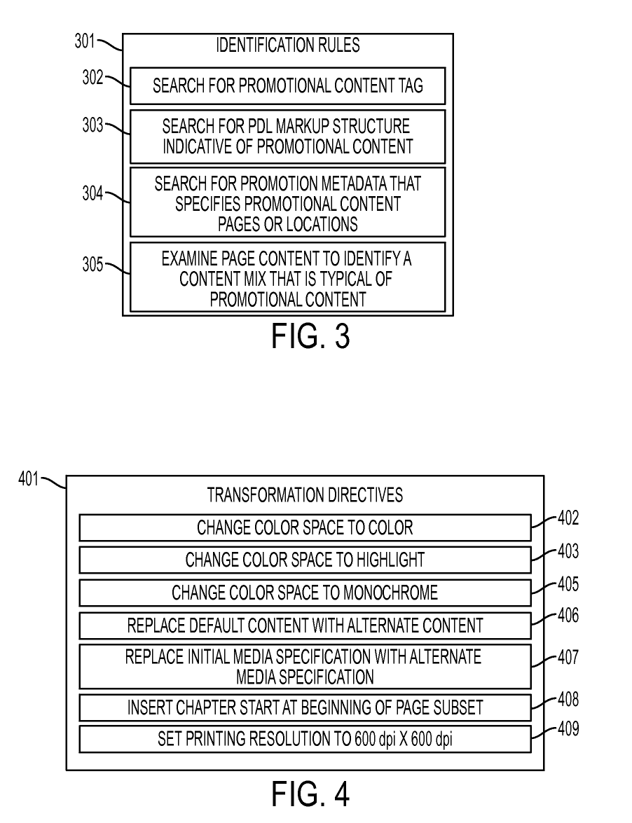

FIG. 3 illustrates examples of identification rules 301 in accordance with aspects of the embodiments. One identification rule is to search for a promotional content tag. For example, <promo> and </promo> could encapsulate the PDL descriptions of promotional content. A second identification rule is to search for a PDL markup structure indicative of promotional content 303. This can occur when certain templates are predictably used for different types of content. A third identification rule is to search for promotion metadata that specifies promotional content pages or locations 304. For example, <utilityBill promopages=1, 3, 6> . . . </utilityBill> could specify that pages 1, 3, and 6 of a utility bill contain promotional content. A fourth identification rule is to examine page content to identify a content mix that is typical of promotional content 305. For example, a utility bill is predominantly text with limited or no graphics. A page containing a large graphic (bigger than a threshold area) or dedicating more than a certain percentage of page space to graphics can be identified as a promotional page. Also note that a page description's content tags or the content itself can be examined for the names of specific companies, products, brands, or combinations thereof to classify the page description into a page subset.

FIG. 4 illustrates examples of transformation directives 401 in accordance with aspects of the embodiments. The first transformation directive is to change the color space to color 402. The second transformation directive is to change the color space to highlight 403. The third transformation directive is to change the color space to monochrome 405. Note that the color space selection determines which inks or pigments are used in printing. A fourth transformation directive is to replace the default content with alternate content 406. Note that in the example of FIG. 2, the alternate content was discarded. A fifth transformation directive is to replace the initial media specification with an alternate media specification 407 as happened to page subset 1 117 and page subset 2 118. A sixth transformation directive is to insert a chapter start at the beginning of a page subset 408. This transformation directive ensure that the first page of the page subset is printed on the front side of a page during two sided printing, preferably the rest of the pages in the subset sequentially follow the first. A seventh transformation directive is to set printing resolution to 600 dpi×600 dpi 409 and is similar the rule that altered the printing resolution of page subset 1 117.

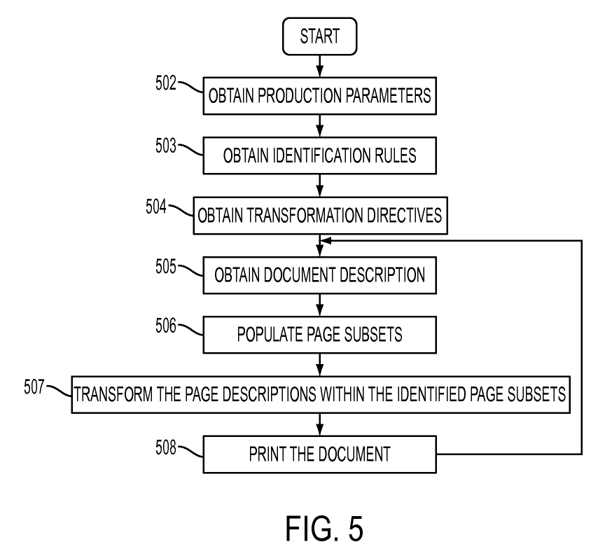

FIG. 5 illustrates a high level flow diagram of producing a document containing pages matching identification rules and transformed by transformation directives in accordance with aspects of the embodiments. After the start 501, the production parameters are obtained 502, the identification rules are obtained 503, and the transformation directives are obtained 504. The system, now ready to process document descriptions, obtains a document description 505. The page descriptions matching identification rules are placed in page subsets 506 and then transformed 507 in conformance with the proper transformation directives. The document is printed 508 and the process loops back to obtain a document description 505.

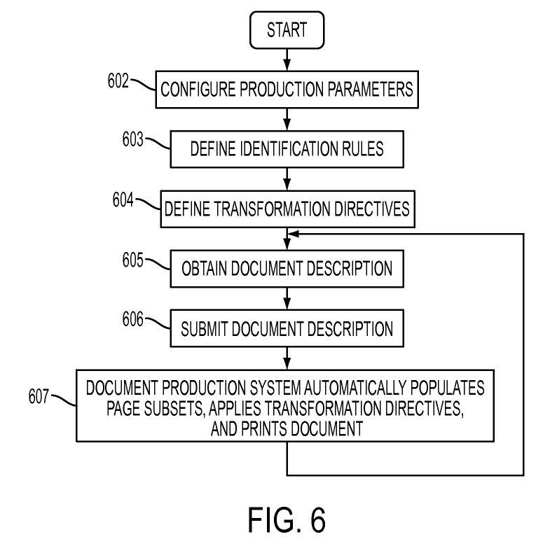

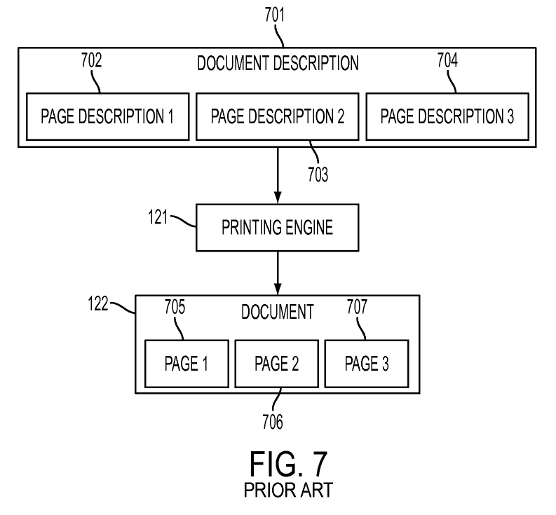

FIG. 6 illustrates a high level flow diagram of configuring and operating a document production system to produce a document containing pages matching identification rules and transformed by transformation directives in accordance with aspects of the embodiments. After the start 601, the production parameters of a document production system are configured 602, the identification rules entered 603, and the transformation directives entered 604. Next a document description is obtained 605 and submitted to the document production system 606. The document production system then identifies page subsets, applies transformation directives, and prints the document 607. The process then loops back to obtaining a document 605.

Another example of an identification rule is a rule seeking a graphic requiring an expanded color gamut. This identification rule would be paired with a transformation directive to instead use the appropriate color in an expanded color gamut. For example, a normal color gamut can use cyan, magenta, yellow, and black (CMYK) to produce all of the colors normally produced. Many printers can handle additional colorants such as a special color. In such a case, the expanded color gamut is CMYKS where S is the special color. The special color can be a color that is hard to reproduce or a color that must be reproduced very precisely. An identification rule can attempt to identify graphics of a trademarked brand logo that uses the special color or can search for CMYK combinations that should be replaced with the trademark color. The transformation directive can then conditionally replace some CMYK colors with CMYKS colors where the C, M, Y, and K components are set to zero or near zero.

Embodiments can be implemented in the context of modules. In the computer programming arts, a module can be typically implemented as a collection of routines and data structures that performs particular tasks or implements a particular abstract data type. Modules generally can be composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A method comprising:
configuring a plurality of production parameters for a document production system wherein the document production system is configured to accept a plurality of document descriptions, wherein each of the document descriptions comprises a plurality of page descriptions, wherein the document description describes a document, and wherein each of the page descriptions describe a page;
defining at least one identification rule for identifying at least one page subset comprising at least one of the page descriptions;
defining at least one transformation directive for transforming one or more of the page descriptions wherein each of the at least one transformation directive is associated with one or more of the at least one identification rule; and
submitting a desired document description to the document production system wherein the document production system identifies the at least one page subset, applies at least one transformation directive to the at least one page subset; and prints the document.

2. The method of claim 1 wherein one of the at least one identification rule identifies promotional content.

3. The method of claim 1 wherein one of the at least one identification rule identifies promotional content by locating a promotional content tag in the page descriptions.

4. The method of claim 1 wherein one of the at least one identification rule identifies a promotional content markup structure in the page descriptions.

5. The method of claim I wherein the desired document description comprises promotion metadata specifying promotional content pages and wherein one of the at least one identification rule identifies the promotion metadata.

6. The method of claim 1 wherein one of the at least one identification rule identifies a page content mix indicative of promotional content.

7. A method performed by a document production system that processes a plurality of document descriptions to produce a plurality of documents, the method comprising:
obtaining a plurality of production parameters for producing the documents from the document descriptions, wherein each of the document descriptions comprises a plurality of page descriptions, and wherein each of the page descriptions describe a page;
obtaining at least one identification rule for identifying at least one page subset comprising at least one of the page descriptions;
obtaining at least one transformation directive that when executed alters one or more of the page descriptions wherein each of the at least one transformation directive is associated with one or more of the at least one identification rule; and
obtaining a desired document description;
identifying the at least one page subset;
applying at least one transformation directive to the at least one page subset; and
printing the document.

8. The method of claim 7 wherein the at least one transformation directive when executed alters an initial color space specification such that the at least one page subset is printed in an altered color space.

9. The method of claim 8 wherein the initial color space is not monochrome and the altered color space is monochrome.

10. The method of claim 8 wherein the initial color space is color and the altered color space is monochrome.

11. The method of claim 8 wherein the initial color space is not highlight color and the final color space is highlight color.

12. The method of claim 7 wherein the at least one page subset specifies a default content description and wherein the transformation directive when executed alters the at least one page subset to instead specify an alternative content description.

13. The method of claim 12 wherein the document description comprises the default content description and further comprises the alternative content description.

14. The method of claim 7 wherein the at least one transformation directive when executed alters an initial media specification such that the at least one page subset is printed onto an alternative media.

15. The method of claim 7 wherein the at least one page subset comprises a first identified page subset and a second identified page subset such that the document description comprises the first identified page subset, the second identified page subset and a document remainder.

16. The method of claim 15 wherein the at least one transformation directive when executed alters at least one initial media specification such that the first identified page subset is printed on a first alternative media, such that the second identified page subset is printed onto a second alternative media subset, and such that the document remainder is printed onto an initially specified media.

17. The method of claim 15 wherein the at least one transformation directive inserts a chapter start into the first identified page subset but not into the second identified page subset nor into the document remainder such that only the first identified page subset is guaranteed to begin on the front side of a page.

18. A document production system comprising:
a document description input that accepts a plurality of document descriptions describing a plurality of documents, wherein each of the document descriptions comprises a plurality of page descriptions, and wherein each of the page descriptions describe a page;
a plurality of production parameters specifying processing the document descriptions into the documents;
an identification module that examines the document descriptions and identifies at least one page subset comprising at least one of the page descriptions;
a page transformation module that transforms each of the at least one page descriptions within at least one of the at least one page subset; and
a printing engine that produces the documents.

19. The system of claim 18 wherein the transformation module alters a resolution specification.

20. The system of claim 18 wherein the identification module identifies a first page subset and at least one additional page subset and wherein the transformation module alters at least one resolution instruction such that the first page subset is printed at an altered resolution and such that the at least one additional page subset and a document remainder are printed at their original resolution.
